(19) United States
(12) Patent Application Publication
(10) Pub. No.: US 2024/0172773 A1
(43) Pub. Date: May 30, 2024

(54) POTATO PROTEIN AND PROCESS FOR MANUFACTURING THEREOF

(71) Applicant: KMC Kartoffelmelcentralen Amba, Brande (DK)

(72) Inventors: Thomas Hannibal, Brande (DK); Ole Bandsholm Sørensen, Brande (DK); Lind Bach Christensen, Brande (DK)

(21) Appl. No.: 18/553,237

(22) PCT Filed: Mar. 28, 2022
(86) PCT No.: PCT/EP2022/058087

§ 371 Date: Sep. 29, 2023

(30) Foreign Application Priority Data
Mar. 31, 2021 (EP) 21166169.9
Dec. 2, 2021 (EP) 21211998.6

(51) Int. Cl. A23J 3/14; A23J 3/22; A23J 3/26

(52) U.S. Cl. CPC A23J 3/14; A23J 3/227; A23J 3/26

(57) ABSTRACT

An extrusion process for manufacturing of a potato protein product. The process conducted at a high temperature and using compositions comprising a large fraction of potato protein in combination with an alkaline salt. An extruded potato protein product is achieved which possess characteristics of meat and meat analogues.

### TECHNICAL FIELD OF THE INVENTION

The present invention relates to a process for extrusion of a food product and/or food ingredient. In particular, the present invention relates to extrusion of food rich in potato protein.

### BACKGROUND OF THE INVENTION

Foods and other products made of plant material is an object of increasing public interest and new or improved methods for their manufacturing is in demand. Foods based on vegetables, such as vegan foods are however sometimes considered cumbersome to produce and develop, particularly if the goal is to provide a plant based food product rich in proteins and contributing to the daily intake of nutrients. Meat-analogues are generally troubled by consumers expecting products that closely resemble the respective meat based product by texture, flavour and sensory qualities.

Protein is a critical component of a complete and healthy diet. Protein is important for building and repairing tissues. It is also necessary for making enzymes, hormones, and other body chemicals that assist in building bones, muscles, cartilage, skin, and blood. The growing world population and decreasing amount of land under agricultural use requires new and plentiful sources of protein. Nutritionists, doctors, and athletes, among others, recommend consuming protein to assist in maintaining health, building muscle and losing fat. Proteins can be found in various animal- and plant-based sources, products and by-products. Some widely used animal-based proteins are obtained directly or indirectly from meat, seafood, eggs, milk and cheese. Today many people choose plant-based protein to reduce the impact on the environment related to production of animal protein or because they are against the way the animals are treated.

Many different sorts of plant proteins are available for the food producers today. As such, the plant protein may be obtained from potato plants (Solanum Tuberosum var.) which are high yield crops with a low impact on the climate. Any part of a potato can be utilized and gently processed into functional and nutritional ingredients. Proteins, starch and fibres may be extracted from the same load of potatoes. Potato protein is considered to be a good substitute for meat proteins, for example in terms of nutritional value. Foods and snacks comprising a high level of potato protein are likely to be popular and healthy substitutes to similar meat products, however the preferences of the consumers must be met in regard to texture and taste.

The extrusion process provides a method for obtaining products of textured vegetable protein (TVP) with properties mainly governed by the mixture of components in the composition to be extruded.

GB1495194 discloses a method for producing a textured vegetable protein. A composition of isolated potato protein and potato pulp is extruded. However, the isolated potato protein is 85% pure but constitutes only 47 w % of the total composition (i.e. 100 parts of protein in respect of 210 part per weight in total). Thus, the protein content of the composition to be extruded is apparently below 43 w %.

In addition, EP3578053 discloses a food product comprising 70 to 85 w % of potato protein, but extruded at a low temperature.

However, extrusion of compositions mostly consisting of protein is generally considered difficult to produce due to poor flow control, e.g. caused by inhomogeneous mixing and/or melting. Generally speaking extruded textured plant proteins are hard to produce and need to be developed for each source of protein.

Thus, a process facilitating extrusion of a composition comprising mostly protein to obtain a nutritional product with the look, taste and texture of meat is considered valuable.

Hence, an improved process for producing an extruded potato protein product would be advantageous, and in particular an improved process for producing an extruded potato protein product with a high protein content would be advantageous.

### SUMMARY OF THE INVENTION

A process for manufacturing of an extruded potato protein product for use as a food. The process involving extrusion of a composition comprising potato protein, alkaline salt, water and optionally other plant based ingredients, such as starches, fibres, and further plant proteins. The potato protein is at least 40% of the total composition and the composition may be extruded at a temperature up to 230° C. The extruded potato protein product obtained by said process may be dried afterwards to contain less than 15% water.

In particular, it is an object of the present invention to provide plant based food products comprising high amounts of plant proteins and also fulfilling the needs of nutritional value and taste. The extruded potato protein product may also possess visual and sensory properties characteristic of meat or a meat analogue, such as by texture, fibrous structure, hydration capacity, density and look.

Adding alkaline salt, such as sodium carbonate, was found to give an extruded potato protein product of increased quality. The inventors were surprised to find that extrusion of compositions comprising the salt resulted in products with increased fibrous structure and texture as compared to products extruded from compositions without the salts. In addition, a better flow was observed during extrusion of compositions comprising said salts thereby facilitating an improvement to the extrusion process.

Thus, a first aspect of the present invention relates to a process for manufacturing of an extruded potato protein product, the process comprising the steps of:
a) providing a composition comprising:
   i) potato protein in an amount of 43 to 94.9 w % of the total weight of the composition,
   ii) one or more alkaline salt in an amount of 0.1 to 5 w % of the total weight of the composition,
   iii) water in an amount of 5 to 50 w % of the total weight of the composition,
   iv) optionally, one or more additional plant based ingredients;
b) extruding the composition of step a) at a maximum temperature in the range of 150 to 230° C.;
whereby an extruded potato protein product is obtained.

As outlined in Example 3, addition of alkaline salt (exemplified with sodium carbonate) in step a) has a positive impact on the fiber structure of the obtained extruded potato protein product.

Example 4 further shows that the same effect can be obtained using other alkaline salts. Example 4 also shows that the pH of the composition is of importance to the fiber structure of the extruded potato protein product. This has been confirmed using a wide range of alkaline salts.

Thus, a further aspect of the invention relates to a process for manufacturing of an extruded potato protein product, the process comprising the steps of:
a) providing a composition having a pH below 5, preferably below 4.5, the composition comprising:
   i) potato protein in an amount of 43 to 94.9 w % of the total weight of the composition;
   ii) water in an amount of 5 to 50 w % of the total weight of the composition,
   iii) optionally, one or more additional plant based ingredients;
b) adjusting the pH of the composition to a pH in the range in the range pH 4.5 to 10, such as 5-10;
c) extruding the composition of step a) at a maximum temperature in the range of 150 to 230° C.;

The extruded potato protein product resulting from extrusion of a composition according to the present invention has properties determined by the extrusion procedure.

A further aspect of the present invention therefore relates to an extruded potato protein product obtained/obtainable by a process according to any of the preceding claims.

An extruded potato protein product of the present invention may for some application be used as an ingredient for producing any further food products, thus being a constituent in a composition, formulation or mixture used in production of such products.

A yet a further aspect of the present invention relates to the extruded potato protein product as described herein, being a food ingredient.

Any food product obtained from a composition comprising the extruded potato protein product or ingredient is also part of the present invention, whereby an aspect of the present invention relates to a food product comprising the extruded potato protein product as described herein or the food ingredient as described herein.

The combination of extrusion parameters and composition specifics according to the present invention results in an extruded potato protein product having visual and sensory properties that are characteristic of meat and products therefore.

Thus, an additional aspect of the present invention relates to use of a composition in an extrusion process for producing a meat analogue, the composition comprising:
i) potato protein in an amount of 43 to 94.9 w % of the total weight of the composition,
ii) one or more alkaline salt in an amount of 0.1 to 5 w % of the total weight of the composition, and
iii) water in an amount of 5 to 50 w % of the total weight of the composition.

### BRIEF DESCRIPTION OF THE FIGURES

FIG. 1 shows, the extruded potato protein product of sample #6.

FIG. 2 shows, the extruded potato protein product of sample #8.

FIG. 3 shows, the extruded potato protein product of sample #11.

FIG. 4A shows, the extruded potato protein product of sample #6 taken with a standard camera, whereas FIG. 4B, shows a picture of the same sample taken with a stereomicroscope. It may be seen from both of these figures that this extruded potato protein product has a filamentous structure.

FIG. 5A shows, the extruded potato protein product of sample #1 taken with a standard camera, whereas FIG. 5B, shows a picture of the same sample taken with a stereomicroscope. It may be seen from both of these figures that this extruded potato protein product is not filamentous.

The present invention will now be described in more detail in the following.

### DETAILED DESCRIPTION OF THE INVENTION

### Definitions

Prior to discussing the present invention in further details, the following terms and conventions will first be defined:

### Extrusion

In the present context, the term “extrusion” refers to a process wherein a composition, such as a mixture, combination or similar, is pushed through an apparatus (i.e. the extruder). An extruder is often equipped with a die at the exit, and may also, without being restricted thereto, include means for heating the composition during the extrusion process and/or for adding more components to the composition during extrusion, such as water. An extrusion may be a continuous process or a single batch process.

### High Moisture Extrusion Cooking (HMEC)

In the present context, in HEMC of vegetable proteins is done with a high (more than 45%) moisture in the barrel and the product leaving the extruder will have a high moisture content, normally above 35% by weight, preferably above 50%.

### Textured Vegetable Protein (TVP)

In the present context, during extrusion of TVP the moisture content in the barrel is low (lower than 45%) in the barrel and the product leaving the extruder will have a low moisture content, normally 25% or below, preferably below 20% by weight, more preferably below 15% and even more preferably below 10%.

In a preferred embodiment of the invention, the extrusion is performed by dry extrusion.

### Potato Protein

In the present context, the term “potato protein” refers to protein obtained from tubers of the plant Solanum tuberosum. The potato protein may for example be obtained as a secondary product in a process for extracting starch from potatoes.

### Native Protein

In the present context, the term “native protein” refers to a protein having its primary structure and native three-dimensional form. This three-dimensional form allowing the protein to function as it would do in its native biological settings.

### Denatured Protein

In the present context, the term “denatured protein” refers to a protein not in its native three-dimensional form. A denatured protein may be obtained from the corresponding native protein, such as for example by heat treatment of the native protein or treatment with a chemical, such as an acid.

### Rework

In the present context, the term “rework” refers to a sample comprising protein and which sample have already been used in one application, such as but not limited to, a food product or ingredient.

### Alkaline Salt

In the present context, the term “alkaline salt” refers to a basic compound which dissolves in water to form a basic solution. A basic compound is a compound comprising one or more cations countered by anions, such as but not limited to carbonates, phosphates, citrates, hydroxides, and oxides.

### Carbonate Compound

In the present context, the term “carbonate compound” refers to a compound comprising one or more carbonate anions (i.e. CO₃²⁻) that are countered by any organic or inorganic cations.

### Textured

In the present context, the term “textured” refers to something that has been processed to achieve a more fibrous structure, however without being restricted to this property only.

### Plant Starch

In the present context, the term “plant starch” refers to starch or a starch containing part (i.e. potato granules or potato flakes) obtained from a plant. Starches are polysaccharides consisting of D-glucose units joined together by glycosidic bonds, preferably α-glycosidic bonds. Starches are produced by many different plant species for storing energy.

### Plant Fibre

In the present context, the term “plant fibre” refers to a filamentous structure obtained from a plant.

Herein is described a process for manufacturing of an extruded potato protein product for use as a food. The process involves extrusion of a composition comprising potato protein, alkaline salt, water and optionally other plant based ingredients, such as starches, fibres, and further plant proteins. The extruded potato protein product is fibrous in structure and possesses a texture, hydration capacity, density and look, which is characteristic of a meat or meat analogue.

The inventors were surprised to find that extrusion of compositions comprising alkaline salt resulted in products with increased fibrous structure and texture as compared to products extruded from compositions without such salts. Moreover, extrusion of compositions comprising the salts were observed to flow better through the apparatus, thus improving the extrusion outcome.

### Processes for Manufacturing Extruded Potato Protein

As also outlined above, the present invention relates to extruded potato protein products, which may possess visual and sensory properties characteristic of meat or a meat analogue, such as by texture, fibrous structure, hydration capacity, density and look.

Thus, a first aspect of the present invention relates to a process for manufacturing of an extruded potato protein product, the process comprising the steps of:
a) providing a composition comprising:
   i) potato protein in an amount of 43 to 94.9 w % of the total weight of the composition,
   ii) one or more alkaline salt in an amount of 0.1 to 5 w % of the total weight of the composition,
   iii) water in an amount of 5 to 50 w % of the total weight of the composition,
   iv) optionally, one or more additional plant based ingredients;
b) extruding the composition of step a) at a maximum temperature in the range of 150 to 230° C.;
whereby an extruded potato protein product is obtained.

As outlined in the example section, addition of alkaline salt (exemplified with sodium carbonate (example 3) and sodium tripolyphosphate (example 4)) in step a) has a positive impact on the fiber structure of the obtained extruded potato protein product.

In an embodiment, in step b) extrusion takes place at a temperature in the range of 150 to 230° C.

The pH of the composition in step a) may also be of importance to the properties of the obtained extruded potato protein product. Thus, in an embodiment, the composition in step a) has a pH in the range pH 4.5 to 10, such as in the range pH 4.5 to 9, preferably in the range 4.8 to 9, such as 5 to 7, such as 5 to 6, more preferably in the range 5.8 to 8, even more preferably in the range 6 to 7, such as 6 to 6.8.

In another preferred embodiment, the composition in step a) has a pH in the range pH 5-6, preferably 5.2 to 5.8, more preferably 5.3 to 5.6.

In another preferred embodiment, the composition in step a) has a pH in the range 5 to 7, preferably in the range 6 to 7, such as 6 to 6.8. As outlined in example 4, different alkaline salts can be used to influence the fiber strength. Further, a correlation between pH and fiber strength has been identified. Thus, the pH may be of importance to the fiber strength of the obtained extruded potato protein product.

Thus, in another aspect the invention relates to a process for manufacturing an extruded potato protein product, the process comprising the steps of:
a) providing a composition having a pH below 5, preferably below 4.5, the composition comprising:
   i) potato protein in an amount of 43 to 94.9 w % of the total weight of the composition;
   ii) water in an amount of 5 to 50 w % of the total weight of the composition,
   iii) optionally, one or more additional plant based ingredients;
b) adjusting the pH of the composition to a pH in the range in the range pH 4.5 to 10, such as 5-10;
c) extruding the composition of step a) at a maximum temperature in the range of 150 to 230° C.;
whereby an extruded potato protein product is obtained.

In an embodiment, in step c) extrusion takes place at a temperature in the range of 150 to 230° C.

An embodiment of the present invention relates to the process, wherein the extrusion of the composition is performed at a barrel temperature of 150 to 220° C., such as 155 to 220° C., such as 160 to 220° C., preferably at a temperature of 165 to 220° C., preferably such as 150 to 190° C., such as at a temperature of 150 to 180° C., more preferably 175-190° C.

Again, as outlined in example 4, the pH is of importance to the fiber strength of the obtained extruded potato protein product

In an embodiment, of the second aspect of the invention, the pH in step b) is adjusted to a pH in the range 4.5 to 9, such as 5 to 7, preferably in the range 4.8 to 9, more preferably in the range 5.8 to 8, even more preferably in the range 6 to 7, such as 6 to 6.8.

In a preferred embodiment, the composition in step a) has a pH in the range pH 5-6, preferably 5.2 to 5.8, more preferably 5.3 to 5.6.

In another preferred embodiment, the pH in step b) is adjusted to a pH in the range 5 to 7, preferably in the range 6 to 7, such as 6 to 6.8. Preferably the adjusting is a raising of the pH.

In another embodiment, of the second aspect of the invention, in step b) the pH is adjusted with one or more alkaline salts, such as to an amount of 0.1 to 5 w % of the total weight of the composition.

In an embodiment of the invention, the one or more alkaline salts are selected from the group consisting of carbonates, phosphates, citrates, hydroxides, and oxides.

In another embodiment of the invention, the alkaline salt comprises one or more cation selected from the group consisting of sodium, calcium, ammonium and potassium.

In a further embodiment of the invention, the one or more alkaline salts are selected from the group consisting of sodium carbonate, sodium hydrogen carbonate, tri-sodium citrate, di-sodium phosphate, sodium tri-polyphosphate, and sodium hydroxide.

In yet a further embodiment of the invention, the one or more alkaline salts is a carbonate compound, preferably sodium carbonate or sodium hydrogen carbonate.

One particular embodiment of the present invention relates to the process, wherein the potato protein is native protein, rework, and/or denatured protein. Preferably, the potato protein is denatured. In the example section, denatured protein is used. One advantage of using denatured protein in the process of the invention compared to e.g. native protein is that the production costs are lower.

The extruded product should be rich in potato protein and a particular embodiment of the present invention therefore relates to the process, wherein the amount of potato protein is in the range from 45 to 94.9 w %, such as 50 to 94.9 w %, such as 55 to 94.9 w %, such as 60 to 94.9 w %, such as 65 to 94.9 w %, based on the total weight of the composition. However, another embodiment of the present invention relates to the process, wherein the amount of potato protein is in the range from 43 to 90 w %, such as 45 to 90 w %, such as 50 to 90 w %, such as 50 to 85 w %, such as 50 to 83 w %, preferably 50 to 80 w %, based on the total weight of the composition.

An extruded potato protein product of particular high quality can be obtained if the composition comprises specific types of salts. Thus, an embodiment of the present invention relates to the process, wherein the alkaline salt is in an amount of 0.1 to 4 w %, such as 0.1 to 3 w %, such as 0.5 to 3 w % based on the total weight of the composition.

An embodiment of the present invention relates to the process, wherein the alkaline salt comprises one or more cation selected from the group consisting of sodium, calcium, ammonium, and potassium.

Alkaline salts comprising carbonate anion(s) are considered particularly relevant for extrusion of a preferred potato protein product. Thus, an embodiment of the present invention relates to the process, wherein the alkaline salt is a carbonate compound comprising sodium or potassium. Though the number of such carbonate compounds is limited, some species of the group tends to give products of high quality. A more specific embodiment of the present invention therefore relates to the process, wherein the carbonate compound is selected from the group of compounds consisting of soda, sodium carbonate (Na₂CO₃), sodium carbonate hydrate (Na₂CO₃ xH₂O), sodium bicarbonate (NaHCO₃), sodium sesquicarbonate (Na₃H(CO₃)₂), potassium carbonate (K₂CO₃), potassium bicarbonate (KHCO₃), and mixtures thereof (e.g. Na₂CO₃·NaHCO₃·2H₂O). A preferred embodiment of the present invention relates to the process, wherein the sodium carbonate hydrate is sodium carbonate decahydrate.

The amount of water impacts the properties of the final product. An embodiment of the present invention therefore relates to the process, wherein the composition comprises water in an amount of 10 to 50 w %, such as 15 to 50 w %, such as 20 to 50 w %, such as 20 to 45 w %, preferably 20 to 15 w % or 20 to 35 w % based on the total weight of the composition.

In some optional embodiments of the present invention, the composition also comprises other additional plant based ingredient(s). The upper limit for the amount of the plant based ingredient(s) is only limited by the fact that the total amount of components of the composition according to step a) and comprising components i) to iii) and the plant based ingredients of iv) cannot exceed 100 w %. Thus, an embodiment of the present invention relates to the process, wherein the additional plant based ingredient is selected from the group consisting of plant protein, plant starch, plant fibre, and combinations thereof. It is to be understood that the additional plant based ingredient is different from potato protein.

The plant protein may be obtained from any plant resource providing protein. A particular embodiment of the present invention relates to the process, wherein the plant protein comprises an additional plant resource selected from the group consisting of pea, soy, canola, rapeseed, wheat, rice, bean, faba bean, chickpea, lentil, algae, gluten, lupine, sunflower, hemp, and combinations thereof.

The plant resource should be rich in plant protein whereby an embodiment of the present invention relates to the process, wherein the plant resource comprises at least 50 w % protein based on the total weight of the plant protein.

A plant starch may be in the form as it naturally occur or it may have been modified chemically, physically, by heat, or by any other methods suitable for producing a starch for use in food. The plant starch is a resource or part of a resource comprising plant starch and/or other components. Thus, an embodiment of the present invention relates to the process, wherein the plant starch comprises a resource selected from the group consisting of native starch, modified starch, pregelatinized native starch or, potato granules, and potato flakes.

Yet, a more specific embodiment of the present invention relates to the process, wherein the plant starch comprises a plant resource selected from the group consisting of potato, rice, corn, oat, wheat, pea, bean, cassava, barley, waxy maize, and waxy potato, preferably potato or waxy potato.

The plant starch should be rich in plant protein whereby an embodiment of the present invention relates to the process, wherein the plant starch comprises at least 50 w %, such as at least 60 w %, preferably at least 80 w % of starch based on the total weight of the plant starch.

The composition may also comprise plant fibres. Thus, an embodiment of the present invention relates to the process, wherein the plant fibre comprises a plant food fibre. However, often the plant fibre is a resource or part of a resource comprising plant fibre and/or other components. Another embodiment of the present invention therefore relates to the process, wherein the plant fibre comprises a plant resource selected from the group consisting of potato, wheat, corn, cassava, carrot, citrus, pea, pear, apple, avocado, date, bean, kidney bean, lima bean, and edame.

The extrusion temperature is associated with melting of specific components in the composition and the flow of the composition through the extruder. The operation temperature is also an important parameter in respect of obtaining an extruded potato protein product with the visual and sensory properties of meat.

Thus, an embodiment of the present invention relates to the process, wherein the extrusion of the composition is performed at a maximum temperature of 150 to 220° C., such as 155 to 220° C., such as 160 to 220° C., such as at a temperature of 165 to 220° C. Yet another embodiment of the present invention relates to the process, wherein the extrusion of the composition is performed at a maximum temperature of 150 to 220° C., such as 150 to 200° C., preferably such as 150 to 190° C., such as at a temperature of 150 to 180° C., more preferably 175-190° C. In the processes according to the present invention, it is important to apply enough energy (temperature) to melt the denatured protein and subsequently assemble into the desired fiber structure.

Yet another embodiment of the present invention relates to the process, wherein the extrusion of the composition is performed at a (barrel) temperature of 150 to 220° C., such as 150 to 200° C., preferably such as 150 to 190° C., such as at a temperature of 150 to 180° C., more preferably 175-190° C.

A further embodiment of the present invention relates to the process, wherein the extrusion of the composition is performed at a temperature measured within the composition during extrusion. Yet, another embodiment of the present invention relates to the process, wherein the extrusion of the composition is performed at a temperature measured on the extruder, such as on the die or on one of the barrels. As such, an embodiment of the present invention relates to the process, wherein the extrusion of the composition is performed at a maximum barrel temperature of 150 to 220° C., such as 155 to 220° C., such as 160 to 220° C., preferably at a temperature of 165 to 220° C., preferably such as 150 to 190° C., such as at a temperature of 150 to 180° C., more preferably 175-190° C.

An embodiment of the present invention relates to the process, wherein the extrusion of the composition is performed at a barrel temperature of 150 to 220° C., such as 155 to 220° C., such as 160 to 220° C., preferably at a temperature of 165 to 220° C., preferably such as 150 to 190° C., such as at a temperature of 150 to 180° C., more preferably 175-190° C.

An embodiment of the present invention relates to the process, wherein the extrusion of the composition is performed using an extruder equipped with a die.

An embodiment of the present invention relates to the process, wherein the die is a non-temperature regulated die.

An embodiment of the present invention relates to the process, wherein the die has at least one hole having a diameter of 2.0 to 15.0 mm, such as 2.5 to 7.0 mm, such as 2.5 to 6.0 mm, such as 2.8 to 5.0 mm.

An embodiment of the present invention relates to the process, wherein water is supplied to the extruder during extrusion of the composition, preferably the water is in the form of liquid, vapour or steam.

When making TVP the extruded potato protein product after leaving the extruder will preferably have a moisture content below 20%, more preferably below 15%, even more preferably below 10%.

Thus, in an embodiment, the extruded potato protein product has a moisture content (water content) below 20% by weight, preferably below 15%, even more preferably below 10%.

The extruded product may be further dried if desired. Thus, in an embodiment of the present invention relates to the process, wherein after extrusion of the composition the extruded potato protein product is dried to contain water in an amount of 4 to 15 w %, such as 4 to 13 w %, such as 5 to 10 w %, preferably 6 to 10 w %.

An embodiment of the present invention relates to the process, wherein the extruded potato protein product is dried at a maximum temperature of 230° C., such as 185° C., such as 150° C., preferably 90° C.

An embodiment of the present invention relates to the process, wherein the extruded potato protein product is dried in a static oven, a band dryer or fluid bed dryer.

### Extruded Potato Protein Product Obtained/Obtainable by Processes of the Invention

A further aspect of the present invention relates to an extruded potato protein product obtained/obtainable by a process as described herein.

An embodiment of the present invention relates to the extruded potato protein product, wherein the product has a hydration power above 115, such as above 130, such as above 140, such as above 180, preferably above 200, most preferably above 240.

A further embodiment of the present invention relates to the extruded potato protein product, wherein the product has a visual filamentous structure. An extruded potato protein product of the present invention may therefore be considered a textured vegetable protein.

Also, an embodiment of the present invention relates to the extruded potato protein product, wherein the product has a density of less than 200 g/L, such as in the range of 1 to 200 g/L, such as 50 to 200 g/L, such as 80 to 200 g/L.

### Food Ingredients

Yet an aspect of the present invention relates to the extruded potato protein product as described herein being a food ingredient.

### Food Products

Yet a further aspect of the present invention relates to a food product comprising the extruded potato protein product as described herein or the food ingredient as described herein.

An embodiment of the present invention relates to the extruded potato protein product as described herein, the food ingredient as described herein and/or the food product as described herein, being selected from the group consisting of meat analogue, fish meat analogue, livestock meat analogue, plant based ground beef, plant based minced meat, plant based meat substitute/analogue, bacon analogue, snack, and variants thereof.

In the present context, the term “snack” is a small amount of food, optionally eaten between meals. A snack may be, but is not limited to, protein bars, confectionery, and chips.

### Uses

A further aspect of the present invention relates to use of a composition in an extrusion process for producing a meat analogue, the composition comprising:
i) potato protein in an amount of 43 to 94.9 w % of the total weight of the composition,
ii) one or more alkaline salt in an amount of 0.1 to 5 w % of the total weight of the composition, and
iii) water in an amount of 5 to 50 w % of the total weight of the composition.

In an embodiment, the composition has a pH in the range pH 4.5 to 9, preferably in the range 4.8 to 9, such as 5 to 7, more preferably in the range 5.8 to 8, even more preferably in the range 6 to 7, such as 6 to 6.8.

In a preferred embodiment, the composition in step a) has a pH in the range pH 5-6, preferably 5.2 to 5.8, more preferably 5.3 to 5.6.

In another preferred embodiment, the composition has a pH in the range 5 to 7, preferably in the range 6 to 7, such as 6 to 6.8.

Yet an aspect of the invention relates to the use of a composition having a pH above 4.5 in an extrusion process for producing a meat analogue, the composition comprising:
i) potato protein in an amount of 43 to 94.9 w % of the total weight of the composition, and
ii) water in an amount of 5 to 50 w % of the total weight of the composition.

In an embodiment, the composition has a pH in the range 4.5 to 9, such as 5 to 7, preferably in the range 4.8 to 9, more preferably in the range 5.8 to 8, even more preferably in the range 6 to 7, such as 6 to 6.8.

In a preferred embodiment, the composition in step a) has a pH in the range pH 5-6, preferably 5.2 to 5.8, more preferably 5.3 to 5.6.

In another preferred embodiment, the composition has a pH in the range 5 to 7, preferably in the range 6 to 7, such as 6 to 6.8.

In another embodiment, the composition further comprises one or more alkaline salts, such as to an amount of 0.1 to 5 w % of the total weight of the composition.

In another embodiment, the one or more alkaline salts are selected from the group consisting of carbonates, phosphates, citrates, hydroxides, and oxides.

In yet another embodiment, the one or more alkaline salts are selected from the group consisting of sodium carbonate, sodium hydrogen carbonate, tri-sodium citrate, di-sodium phosphate, sodium tri-polyphosphate, and sodium hydroxide.

In a further embodiment, the one or more alkaline salts is a carbonate compound, preferably sodium carbonate or sodium hydrogen carbonate.

In a related embodiment, the one or more alkaline salts is a carbonate compound, such as selected from the group of compounds consisting of soda, sodium carbonate (Na₂CO₃), sodium carbonate hydrate (Na₂CO₃ xH₂O), sodium bicarbonate (NaHCO₃), sodium sesquicarbonate (Na₃H(CO₃)₂), potassium carbonate (K₂CO₃), potassium bicarbonate (KHCO₃), and mixtures thereof, such as Na₂CO₃·NaHCO₃·2H₂O, preferably sodium carbonate such as sodium carbonate hydrate, such as sodium carbonate decahydrate.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

### Example 1—Materials

Denatured Potato Protein (DPP) was prepared by thermocoagulation at low pH followed by washing in dilute inorganic acid; the protein content was 83% (w/w). In addition to DPP, potato granules, native and modified potato starch, and pea protein concentrate were also used in the extrusion process and obtained from KMC, Brande, Denmark. Pea protein concentrate were obtained from Vestkorn, Tau, Norway. Sodium carbonate obtained from Sequens Minerals, France.

The different components of the potato derived products and pea protein concentrate used in the extrusion process are shown in Table 1.

TABLE 1
Components of potato derived products and pea protein concentrate.

| | Potato starch | Potato granules | Pea protein |
|---|---|---|---|
| Component | (%) | (%) | concentrate (%) |
| Dry matter | 80 | 90 | >90 |
| Protein | <0.1 | 7.7 | 55 |
| Carbohydrates | 80.3 | 77.1 | 17 |
| Fibre | <0.5* | 6.4* | 16 |
| Fat | <0.5 | 1.0 | 5 |

*percentage of the total carbohydrates. Nutrients are based on dry matter.

### Example 2—Extrusion

### Aim of Study

The goal was to create compositions comprising high amounts of potato protein and then extrude these compositions using different settings and parameters for the extrusion process, thus to obtain an extruded potato protein product with properties similar or resembling meat or a meat based products.

### Procedure

TVP material was produced on a twin-screw extruder EV44+ from Clextral, France. Mixtures of DPP, potato based ingredients, pea protein concentrate and sodium carbonate were mixed according to Table 2 and Table 3.

TABLE 2
Potato based raw material mixtures (% w/w) before extrusion.

| | Sample | | | | | | | | | | |
|---|---|---|---|---|---|---|---|---|---|---|---|
| Component | #1 | #2 | #3 | #4 | #5 | #6 | #7 | #8 | #9 | #10 | #11 |
| Denatured | 70.3 | 70.1 | 79.9 | 89.7 | 79.9 | 79.9 | 79.9 | 79.9 | 79.9 | 98 | 98 |
| protein isolate | | | | | | | | | | | |
| Potato granules | | 28.5 | 18.5 | 8.5 | | | | | | | |
| Native potato | | | | | 18.5 | | | | 10 | | |
| starch | | | | | | | | | | | |
| Cold water | 29.7 | | | | | 18.5 | | | 8.5 | | |
| swelling native | | | | | | | | | | | |
| potato starch | | | | | | | | | | | |
| Modified potato | | | | | | | 18.5 | | | | |
| starch | | | | | | | | | | | |
| Cold water | | | | | | | | 18.5 | | | |
| swelling | | | | | | | | | | | |
| modified potato | | | | | | | | | | | |
| starch | | | | | | | | | | | |
| Sodium | | 1.4 | 1.6 | 1.8 | 1.6 | 1.6 | 1.6 | 1.6 | 1.6 | 2 | 2 |
| carbonate | | | | | | | | | | | |

TABLE 3
Potato and pea based raw material mixtures (% w/w) before extrusion.

| | Sample | |
|---|---|---|
| Component | #12 | #13 |
| Denatured protein isolate | 70.1 | 84.8 |
| Pea protein concentrate | 28.5 | 13.5 |
| Sodium carbonate | 1.4 | 1.7 |

The raw material mixtures were fed from two feeders; one feeder with DPP and sodium carbonate and another feeder with the other constituent of the individual mixtures, with a total throughput of 100 kg/h. 15-30 kg water/h was added, optionally by preconditioning. The screw speed was adjusted between recipes and varied between 500 and 800 rpm. The temperature profile in all cases was that in the highest temperature was 195° C., and the highest exit temperature was 194° C. At the end of the barrel section a die plate of either 12 holes of a diameter of 2.8 mm or 5 holes of a diameter of 15 mm was placed. Material leaving the barrel was cut into smaller pieces with a rotating cutter equipped with 4 rotational blades and 2 monoblock blades. After extrusion all samples were dried for 30 min at 90° C.

As an example, extruder and supply settings for samples #6, #8, #9 and #11 are shown in Table 4.

TABLE 4
Examples of extruder and supply settings for selected samples.

| | | Sample | | | |
|---|---|---|---|---|---|
| Setting | Units | #6 | #8 | #9 | #11 |
| feeder 1 | kg/h | 81.5 | 81.5 | 81.5 | 100 |
| feeder 2 | kg/h | 18.5 | 18.5 | 18.5 | 0 |
| water preconditioner | kg/h | 8 | 8 | 0 | 0 |
| steam | kg/h | 8 | 8 | 0 | 8 |
| preconditioner | | | | | |
| water extruder | kg/h | 13 | 13 | 27 | 15 |
| propeller | rpm | 180 | 180 | 150 | 180 |
| bottom screw | rpm | 0 | 0 | 90 | 0 |
| preco material temp. | ° C. | 64 | 67 | 24 | 67 |
| screw speed | rpm | 550 | 550 | 500 | 500 |
| torque | % | 43 | 45 | 39 | 58 |
| gear box pressure | bar | 45 | 46 | 41 | 30 |
| barrel 1 temperature | ° C. | 45/51 | 45/50 | 45/42 | 50/54 |
| barrel 2 temperature | ° C. | 80/81 | 80/81 | 80/77 | 80/79 |
| barrel 3 temperature | ° C. | 110 | 110/111 | 110/105 | 110/105 |
| barrel 4 temperature | ° C. | 145/146 | 145/144 | 145/139 | 135/133 |
| barrel 5 temperature | ° C. | 170/172 | 170/171 | 175/170 | 150/151 |
| barrel 6 temperature | ° C. | 160/176 | 160/162 | 195/193 | 150/155 |
| material pressure | bar | 43 | 47 | 42 | 33 |
| material | ° C. | 171 | 177 | 188 | 174 |
| temperature | | | | | |
| cutter | rpm | 800 | 800 | 800 | 800 |
| | | (4 blades) | (2 mono) | (2 mono) | (2 mono) |

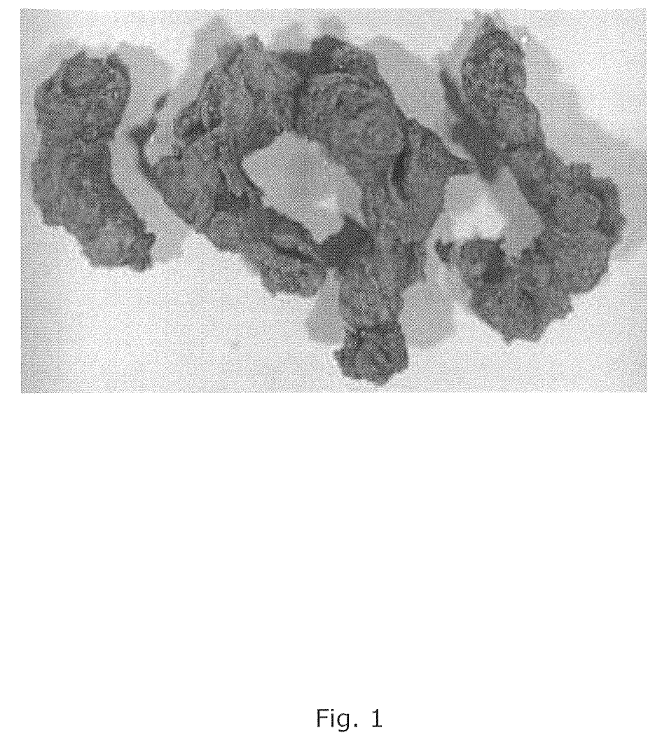

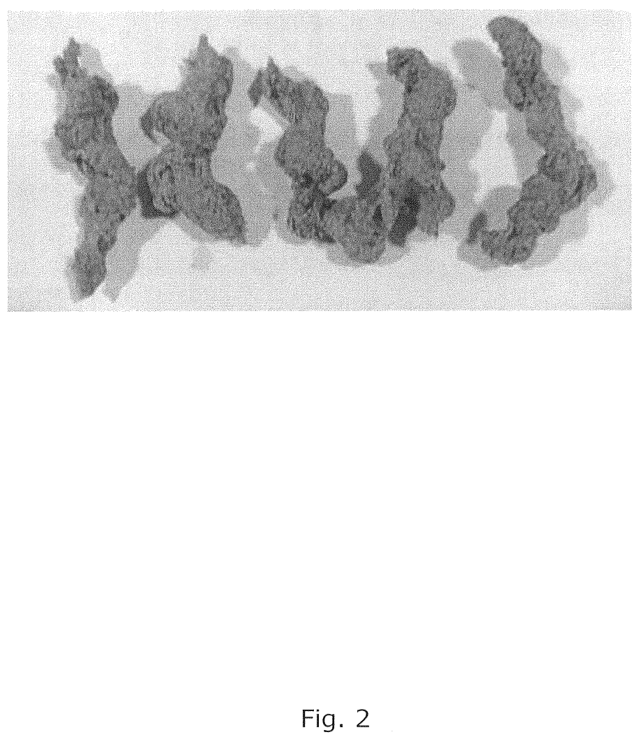

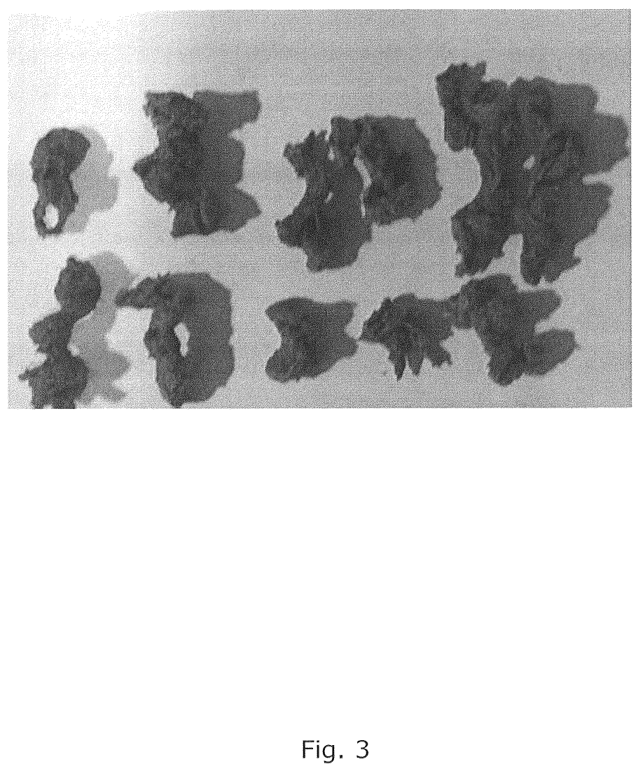

All raw material mixtures resulted in extruded and textured potato protein products of various quality. Pictures of the extruded products are shown in FIGS. 1, 2 and 3, respectively.

The extruded and textured potato protein products were all dried to a moisture content below 10%

### Example 3—Analysis of the Extruded Potato Protein Product

### Aim of Study

To characterize the extruded products by their properties, such as density, hydration capacity and texture.

### Density

A 1000 ml cylinder was placed on a scale, and the scale was tarred. The extruded potato protein products were filled to the 1000 mL mark, and the cylinder was weighed again. The weight was used as density in g/L and is listed in Table 5.

TABLE 5
Density of the extruded potato protein products.

| | Sample | | | | | | | | | | | | |
|---|---|---|---|---|---|---|---|---|---|---|---|---|---|
| | #1 | #2 | #3 | #4 | #5 | #6 | #7 | #8 | #9 | #10 | #11 | #12 | #13 |
| (g/L) | 213 | 170 | 141 | 113 | 132 | 90 | 108 | 93 | 108 | 145 | 164 | 131 | 138 |

### Hydration Capacity

Hydration capacity is a measure of the amount (grams) of water one gram of the extruded potato protein product absorbs when soaked in cold water. 15 grams of an extruded potato protein product was added to a beaker. 200 grams of cold water was added and mixed for a few seconds to ensure that all of the dry extruded potato protein product was soaked. The mixture was left at room temperature for 2, 4 and 6 min. Then the water was decanted from the extruded potato protein product until the water was no longer running/dripping from the beaker. The now hydrated extruded potato protein product was weighed and the hydration power calculated (weight of the hydrated extruded potato protein product−weight of the dry extruded potato protein product)/weight of the dry extruded potato protein product. The hydration power of a range of different extruded potato protein products are listed in table 6.

Table 6 shows that adding sodium carbonate to the raw material mixture before extrusion, increased the hydration power at least two-fold. Sample #7 had the highest water uptake.

TABLE 6
Hydration power of the extruded potato protein products.

| | Hydration power | | |
|---|---|---|---|
| Sample | 2 min | 4 min | 6 min |
| #1 | 88.2 | 90.7 | 111.2 |
| #2 | 246.7 | 330.7 | 369.0 |
| #3 | 182.7 | 224.4 | 248.5 |
| #4 | 307.5 | 339.0 | 348.2 |
| #5 | 198.6 | 261.5 | 298.0 |
| #6 | 350.5 | 417.0 | 420.7 |
| #7 | 390.8 | 420.5 | 425.9 |
| #8 | 315.5 | 380.0 | 398.7 |
| #9 | 392.8 | 416.0 | 419.5 |
| #10 | 256.2 | 292.5 | 308.6 |
| #11 | 145.2 | 184.7 | 216.9 |
| #12 | 223.1 | 298.5 | 326.6 |
| #13 | 139.1 | 180.3 | 222.6 |

### Evaluation of Fibrous Structure

In order to mimic meat fibers, an extruded potato protein product need to have a clear fibrous structure after hydration. Fibrous structure was defined by bundles of visually clear aligned fibers. Pictures of the hydrated extruded potato protein product (15 g of dry product to 200 ml of water, hydrated for 6 minutes) were taken with a standard camera, while microscopic images were taken in a stereomicroscope.

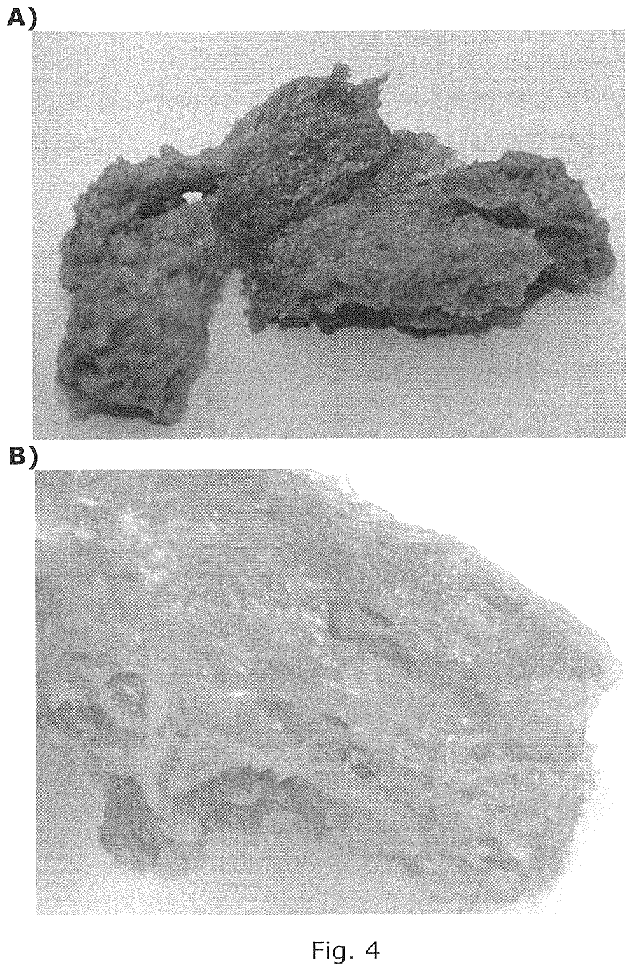

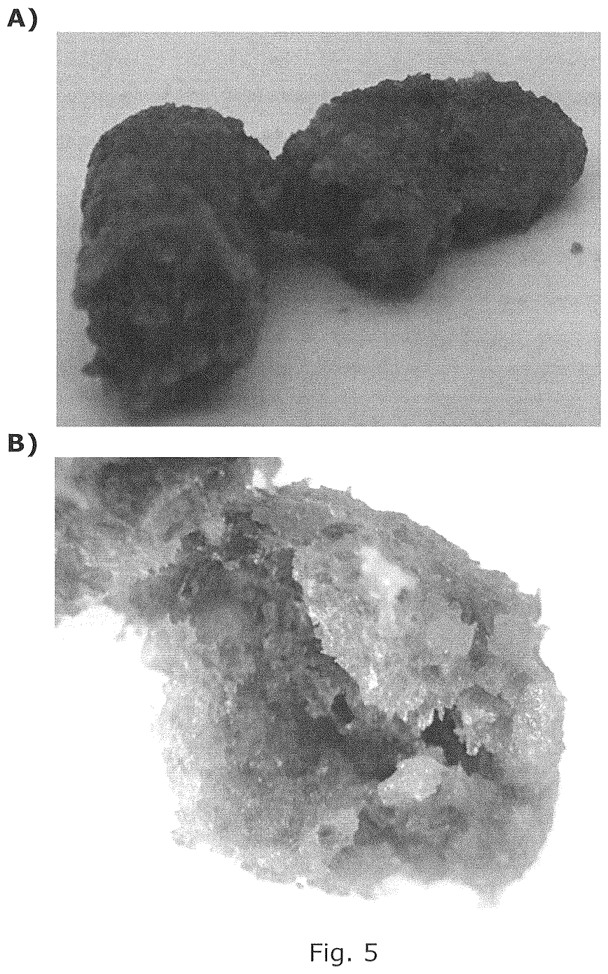

In the current example, FIGS. 4A and 4B show what was meant with clear visual fibers, whereas FIGS. 5A and 5B illustrates an extruded potato protein product without a fibrous structure. The extruded potato protein product in FIGS. 4A and 4B were extruded with sodium carbonate (i.e. sample #6), while the products in FIGS. 5A and 5B were extruded without sodium carbonate (i.e. sample #1). In addition, all samples extruded in presence of sodium carbonate were fibrous in structure, suggesting sodium carbonate to be key in obtaining a fibrous product.

Addition of sodium carbonate to the compositions to be extruded thus results in products that are more fibrous and textured.

### Example 4—Effect of pH on Fiber Strength in Potato Based Textured Vegetable Protein

### Aim:

The aim of the study was to evaluate the effect of addition of alkaline salts to the raw material mixture before extrusion on the strength of the fibers in the rehydrated extruded product. The extrusion process does not change pH.

### Materials and Methods:

Final pH was measured in the extruded products containing from 0% to 2% alkaline salt (in % of total protein). The textured protein was grinded, and 5 grams were dispersed in 50 grams of demineralized water. The solution was left at room temperature for 5 minutes before pH measurement.

The effect of a broader range of alkaline salts products and -dosages was evaluated by adding sodium carbonate, sodium hydrogen carbonate, tri-sodium citrate, di-sodium phosphate, sodium tri-polyphosphate or sodium hydroxide in dosages of 0.50% to 5%. A reference with no addition of alkaline salts was also included. alkaline salts were added to solutions containing 10 grams of protein and 100 grams of demineralized water, and pH was measured after 30 min at room temperature.

Evaluation of fiber strength was performed by sensory evaluation. Textured samples were hydrated in a 1:2 ratio (TVP:water) for 5 min and the strength of the protein fibers were compared and the fiber strength evaluated on a scale from 0 to 5, where 0 represented samples with no fiber strength and 5 represented very strong fibers.

### Results:

### ph Measurement in Texturates:

The pH in the textured proteins with varying dosages of alkaline salt during extrusion are listed in Table 7.

TABLE 7
Effect of alkaline salt and its dosage on pH and fiber strength in potato-
based TVPs of varying compositions.

| Alkaline salt | Dosage (%) | PH | Fiber strength (0-5) |
|---|---|---|---|
| — | 0 | 4.25 | 0 |
| Sodium tripolyphosphate | 1 | 4.83 | 1 |
| Sodium carbonate | 0.50 | 4.93 | 2 |
| Sodium carbonate | 0.75 | 5.19 | 2 |
| Sodium carbonate | 1 | 5.40 | 3 |
| Sodium carbonate | 1 | 5.66 | 4 |
| Sodium carbonate | 2 | 6.72 | 5 |

From Table 7 it is evident, that increasing dosage of alkaline salt from 0% to 2% increased pH and also affected the fiber strength markedly.

### Measurements of pH in Raw Material:

The effect of different alkaline salts on pH in the protein raw material is shown in Table 8. A reference sample without addition of alkaline salt showed a pH of 4.20.

TABLE 8
Effect of different dosages of a range of alkaline salt on pH in the protein
raw material. pH was measured after 30 min at room temperature.

| | pH | | | | | | | | | | |
|---|---|---|---|---|---|---|---|---|---|---|---|
| Dosage of alkali (%) | 0.5 | 1 | 1.25 | 1.5 | 1.75 | 2 | 2.25 | 2.5 | 3 | 4 | 5 |
| Sodium | 5.1 | 5.9 | 6.1 | 6.6 | 6.7 | 6.8 | 6.9 | 6.9 | 7.2 | 10.2 | 10.3 |
| carbonate | | | | | | | | | | | |
| Sodium | 7.0 | 7.2 | — | 7.4 | — | 7.4 | — | — | 7.7 | 7.8 | 7.8 |
| hydrogen | | | | | | | | | | | |
| carbonate | | | | | | | | | | | |
| Tri-sodium | 4.5 | 4.7 | 4.8 | 4.9 | 5.0 | 5.0 | 5.1 | 5.1 | 5.3 | — | — |
| citrate | | | | | | | | | | | |
| Di-sodium | 4.6 | 4.9 | 5.1 | 5.3 | 5.4 | 5.6 | 5.7 | 5.8 | 6.1 | 7.4 | 7.5 |
| phosphate | | | | | | | | | | | |
| Sodium tri- | 4.6 | 4.9 | 5.0 | 5.1 | 5.2 | 5.4 | 5.4 | 5.5 | 5.7 | — | — |
| polyphosphate | | | | | | | | | | | |
| Sodium | 5.5 | 6.7 | — | 7.8 | — | 9.0 | — | — | — | — | — |
| hydroxide | | | | | | | | | | | |

From Table 8 it is clear that adding alkaline salt in the dosages used in the current study, increased the pH of the solutions. Different alkaline salt increased pH to a varying extend. Sodium hydroxide and sodium carbonate showed the largest effect on pH increase, while tri-sodium citrate showed the lowest effect.

By comparing the pH values in Table 7 and Table 8 it can be concluded that pH increased by addition of alkaline salt in the dosages applied to either the protein raw material (Table 8) or during extrusion and thereby in the texturates (Table 7) in the current study correlate. This means that the knowledge of the dosages of alkaline salt and its effect on the pH in the raw material, can be directly transferred to the effect of alkaline salt and its effect on pH increase in the textured proteins.

### Conclusion:

From the results obtained in the current study, it is evident that alkaline salt can increase the pH similarly of both the protein raw material and also the textured protein. Furthermore, it is clear by increasing the pH of the texturates, the strength of the fibers increased.

It is concluded that pH can be increased with a range of alkaline salts with different dosages, and thus increased pH can increase the strength of the fibers in protein texturates.

The favorable pH to give a good fiber strength is from pH 4.8 to 9 and most favorable from pH 5.8 to 8 and even more favorable from 6-7, such as 6 to 6.8.

1-35. (canceled)

36. A process for manufacturing of an extruded potato protein product, the process comprising the steps of:
a) providing a composition comprising:
i) potato protein in an amount of 43 to 94.9 w % of the total weight of the composition,
ii) one or more alkaline salt in an amount of 0.1 to 5 w % of the total weight of the composition,
iii) water in an amount of 5 to 50 w % of the total weight of the composition,
b) extruding the composition of step a) at a temperature in the range of 150 to 230° C.;
whereby an extruded potato protein product is obtained.

37. The process according to claim 36, wherein the composition in step a) has a pH in the range 4.5 to 10.

38. The process according to claim 36, wherein the composition in step a) has a pH in the range 5 to 7.

39. The process according to claim 36, wherein the one or more alkaline salts are selected from the group consisting of carbonates, phosphates, citrates, hydroxides, and oxides.

40. The process according to claim 36, wherein the one or more alkaline salts are selected from the group consisting of sodium carbonate, sodium hydrogen carbonate, tri-sodium citrate, di-sodium phosphate, sodium tri-polyphosphate, and sodium hydroxide.

41. The process according to claim 36, wherein the one or more alkaline salts is a carbonate compound, selected from the group of compounds consisting of soda, sodium carbonate (Na₂CO₃), sodium carbonate hydrate (Na₂CO₃ xH₂O), sodium bicarbonate (NaHCO₃), sodium sesquicarbonate (Na₃H(CO₃)₂), potassium carbonate (K₂CO₃), potassium bicarbonate (KHCO₃), and mixtures thereof, such as Na₂CO₃·NaHCO₃·2H₂O, preferably sodium carbonate such as sodium carbonate hydrate, such as sodium carbonate decahydrate.

42. The process according to claim 36, wherein the potato protein is native protein, rework, and/or denatured protein.

43. A process for manufacturing of an extruded potato protein product, the process comprising the steps of:
a) providing a composition having a pH below 5, the composition comprising:
i) potato protein in an amount of 43 to 94.9 w % of the total weight of the composition;
ii) water in an amount of 5 to 50 w %, of the total weight of the composition,
b) adjusting the pH of the composition to a pH in the range in the range pH 5 to 10;
c) extruding the composition of step a) at a temperature in the range of 150 to 230° C.;
whereby an extruded potato protein product is obtained.

44. The process according to claim 43, wherein in step b) the pH is adjusted with one or more alkaline salts.

45. The process according to claim 43, wherein in step b) the pH is adjusted with one or more alkaline salts selected from the group consisting of carbonates, phosphates, citrates, hydroxides, and oxides.

46. The process according to claim 43, wherein in step b) the pH is adjusted with one or more alkaline salts, wherein the one or more alkaline salts are selected from the group consisting of sodium carbonate, sodium hydrogen carbonate, tri-sodium citrate, di-sodium phosphate, sodium tri-polyphosphate, and sodium hydroxide.

47. The process according to claim 43, wherein in step b) the pH is adjusted with one or more alkaline salts, wherein the one or more alkaline salts is a carbonate compound, selected from the group of compounds consisting of soda, sodium carbonate (Na₂CO₃), sodium carbonate hydrate (Na₂CO₃ xH₂O), sodium bicarbonate (NaHCO₃), sodium sesquicarbonate (Na₃H(CO₃)₂), potassium carbonate (K₂CO₃), potassium bicarbonate (KHCO₃), and mixtures thereof.

48. The process according to claim 43, wherein the alkaline salt is in an amount of 0.1 to 4 w % based on the total weight of the composition.

49. The process according to claim 43, wherein the composition comprises water in an amount of 10 to 50 w % based on the total weight of the composition.

50. The process according to claim 43, wherein the obtained extruded potato protein product is selected from the group consisting of meat analogue, fish meat analogue, livestock meat analogue, plant based ground beef, plant based minced meat, plant based meat substitute/analogue, bacon analogue, snack, and variants thereof.
